(19) United States
(12) Patent Application Publication
(10) Pub. No.: US 2013/0256193 A1
(43) Pub. Date: Oct. 3, 2013

(54) PROCESS AND SYSTEM FOR THE ADDITION OF PROMOTER METAL DURING OPERATION IN A CATALYTIC REFORMING UNIT

(71) Applicants: Mark P. Lapinski, Aurora, IL (US); Kurt M. VandenBussche, Lake in the Hills, IL (US); Manuela Serban, Glenview, IL (US)

(72) Inventors: Mark P. Lapinski, Aurora, IL (US); Kurt M. VandenBussche, Lake in the Hills, IL (US); Manuela Serban, Glenview, IL (US)

(73) Assignee: UOP LLC, Des Plaines, IL (US)

(21) Appl. No.: 13/433,617

(22) Filed: Mar. 29, 2012

(51) Int. Cl. C10G 35/04; C10G 35/06; B01J 19/00; C10G 35/12

(52) U.S. Cl. 208/134; 422/625

(57) ABSTRACT

One exemplary embodiment can be a process for facilitating adding a promoter metal to at least one catalyst particle in situ in a catalytic naphtha reforming unit. The process can include introducing a compound comprising the promoter metal to the catalyst naphtha reforming unit and adding an effective amount of the promoter metal from the compound comprising the promoter metal to the catalyst particle under conditions to effect such addition and improve a conversion of a hydrocarbon feed.

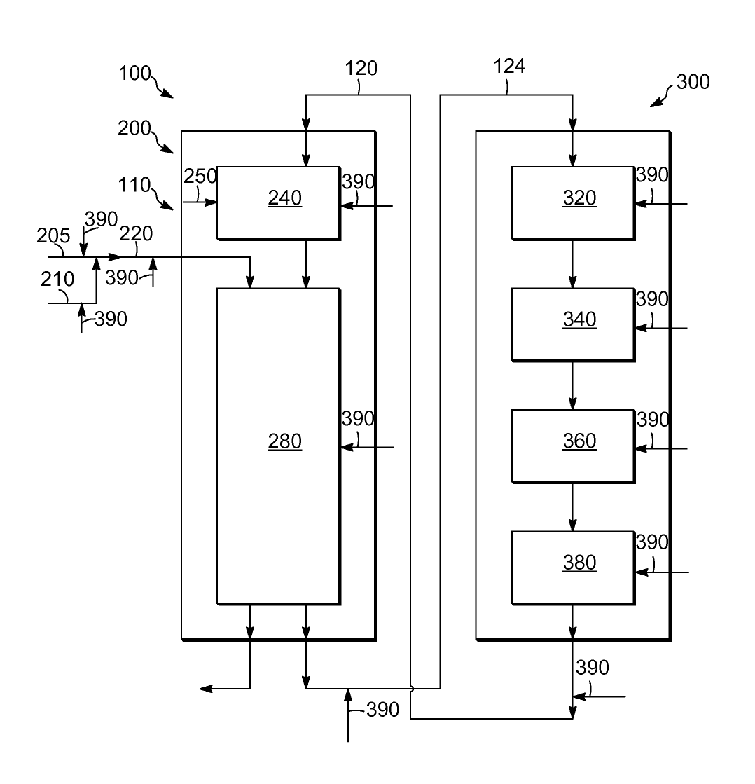

### FIELD OF THE INVENTION

The field of this invention generally relates to a process for conversion of hydrocarbons in a catalytic reforming unit.

### DESCRIPTION OF THE RELATED ART

Numerous hydrocarbon conversion processes can be used to alter the structure or properties of hydrocarbon streams. Generally, such processes include: isomerization from straight chain paraffinic or olefinic hydrocarbons to more highly branched hydrocarbons, dehydrogenation for producing olefinic or aromatic compounds, dehydrocyclization to produce aromatics and motor fuels, alkylation to produce commodity chemicals and motor fuels, transalkylation, and others.

Typically such processes use catalysts to promote hydrocarbon conversion reactions. As the catalysts deactivate, it is generally desirable to regenerate them and/or add new catalyst to improve yields and profitability.

Various catalysts and processes have been developed to convert hydrocarbons. Often, such processes require periodic regeneration to recover lost catalytic activity and/or selectivity due to deactivation. Generally for fixed bed reforming units, the shutting down of the production unit is conducted to regenerate the catalyst whereas for a moving bed or cyclic reforming unit, the catalyst can be regenerated without a unit shutdown. Eventually catalysts can be replaced due to a variety of reasons, one of which being that a new, more profitable catalyst is available. A new catalyst may offer benefits such as increased activity, improved selectivity, reduced deactivation, and/or extended catalyst life. It is known in the art that catalyst performance can be improved by the inclusion of various promoters to standard catalytic naphtha reforming catalysts that contain platinum. These promoters are incorporated in the catalyst in the manufacturing of the catalyst prior to loading the catalyst in the commercial reforming unit. Generally, one drawback of replacing an existing catalyst with a new catalyst is the cost of replacing a large volume of catalyst, especially if the existing catalyst is not at its useful end of life. It would be desirable to provide a process that permits the in situ alternation of catalyst by the addition of at least one promoter component to the existing catalyst in the commercial unit while the unit is operating to improve the performance thus saving the catalyst reload costs and minimizing the amount of processing downtime associated with unloading an existing catalyst and reloading of a new catalyst.

### SUMMARY OF THE INVENTION

One exemplary embodiment can be a process for adding a promoter metal catalyst component in situ to a catalytic naphtha reforming unit. The process can include introducing a compound comprising the promoter metal catalyst component to the catalytic reforming process under conditions to effect deposition of the promoter metal onto the catalyst particle and improve a conversion of a hydrocarbon feed. Selectivity of the catalyst particle may be improved, activity of the catalyst particle may be improved, deactivation of the catalyst particle may be reduced, undesired coking behavior of the catalyst particle may be reduced, or any combination of the above.

Another exemplary embodiment can be a process for adding a promoter metal to at least one catalyst particle in a reduction zone or a reaction zone of a reforming unit. It is generally the case that the promoter metal will be added to a large quantity of catalyst particles such as present in a commercial catalytic naphtha reforming unit, but for simplicity and ease of understanding and without narrowing the scope of the invention, the invention is described herein in terms of a catalyst particle.

A further exemplary embodiment can be a system for the in situ addition of a promoter metal to a catalyst particle in a reforming unit including a first zone having a reducing atmosphere and a second zone having an oxidizing atmosphere. The system may include the reforming unit containing at least one compound comprising the promoter metal added to at least one catalyst particle. The reforming unit may be operated at conditions to facilitate the addition of an effective amount of the promoter metal to the at least one catalyst particle for increasing the effectiveness of the catalyst particle to catalyze reforming reactions. Therefore, a process and system disclosed herein can provide several benefits. Generally, a compound comprising a promoter metal is provided that can add an effective amount of the promoter metal, such as an alkali or alkaline earth metal, e.g. lithium, sodium, potassium, rubidium, cesium, beryllium, magnesium, calcium, strontium, or barium. Other metals may be used in addition to the alkali or alkaline earth metals such as tin or germanium; rare earth metals (lanthanide series), e.g. cerium, lanthanum, europium; and other metals such as phosphorus, nickel, iron, tungsten, molybdenum, titanium, zinc, or cadmium to a catalyst particle. The compound comprising the promoter metal can react so as to add the promoter metal to the catalyst particle. Such an addition can improve the performance to generate a greater amount of the highly desired products (selectivity), increase conversion (activity), and/or decrease undesired deactivation characteristics of the catalyst particle that initially did not contain or had insufficient amounts of the promoter metal. Such an addition can also increase the level of a promoter metal of the catalyst particle to provide further performance benefits. In one embodiment, the compound comprising the promoter metal may be introduced to a moving bed continuous regeneration naphtha reforming process unit at the oxychlorination zone or other regeneration zones. In another embodiment, the compound comprising the promoter metal is introduced to the regeneration gas of a fixed bed naphtha reforming unit during the oxychlorination step or other regeneration steps when the catalyst is being regenerated.

### DEFINITIONS

As used herein, the term “zone” can refer to an area including one or more equipment items and/or one or more sub-zones. Equipment items can include one or more reactors or reactor vessels, heaters, separators, hoppers, drums, exchangers, pipes, valves, pumps, compressors, blowers, and controllers. Additionally, an equipment item, such as a reactor or vessel, can further include one or more zones or sub-zones.

As used herein, the term “stream” can be a stream including various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the hydrocarbon molecule.

As used herein, the term “metal” generally means an element that forms positive ions when its compounds are in solution.

As used herein, the term “catalytically effective amount” generally means an amount on a catalyst support to facilitate the reaction of at least one compound of a hydrocarbon stream. Typically, a catalytically effective amount is at least about 0.005%, preferably about 0.05%, and optimally about 0.10%, based on the weight of the catalyst.

As used herein, the term “promotionally effective amount” generally means an amount on a catalyst support to increase catalytic performance in a conversion of a hydrocarbon stream to, e.g., facilitate the reaction of at least one compound in the stream. Typically, a promotionally effective amount is at least about 0.005%, preferably about 0.05%, and optimally about 0.10%, based on the weight of the catalyst.

As used herein, the term “effective amount” includes amounts that can improve the catalytic performance and/or facilitate the reaction of at least one compound of a hydrocarbon stream.

As used herein, the term “conditions” generally means process conditions such as temperature, reaction time, pressure, and space velocity, and can include an atmosphere including an oxidizing agent or a reducing agent.

As used herein, the term “oxidizing” generally refers to an environment facilitating a reaction of a substance with an oxidizing agent, such as oxygen.

As used herein, the term “reducing” generally refers to an environment facilitating a substance to gain electrons with a reducing agent, such as hydrogen.

As used herein, the term “support” generally means a porous carrier material that can optionally be combined with a binder before the addition of one or more additional catalytically active components, such as a noble metal, or before subjecting the support to subsequent processes such as oxychlorination or reduction.

As used herein, the term “halogen component” generally means a halide ion or any molecule that contains a halide. A halogen can include chlorine, fluorine, bromine, or iodine. As an example, a halogen component can include a halogen, a hydrogen halide, a halogenated hydrocarbon, and a compound including a halogen and a metal. Typically, a halogen component is comprised in a particle and/or a catalyst.

As used herein, the term “halogen-containing compound” generally means any molecule that contains a halide. A halogen can include chlorine, fluorine, bromine, or iodine. Typically, a halogen-containing compound can be part of a gas stream and include compounds such as chlorine, hydrogen chloride, or perchloroethylene, and may provide a halogen component to a catalyst.

As used herein, the term “particle” generally means a catalyst particle receiving a promoter metal. The term “catalyst” can refer to catalyst that is active or has become less active or even inactive while processing and converting feed, such as through the deposition of coke.

As used herein, the term “compound comprising a promoter metal” generally means a molecule or chemical species that contains at least one promoter metal.

### BRIEF DESCRIPTION OF THE DRAWING

The FIGURE is a schematic depiction of an exemplary catalytic naphtha reforming or reforming unit.

### DETAILED DESCRIPTION

The in situ addition of an effective amount of a promoter metal can occur in units having fixed or moving beds. Preferably, the unit has a moving bed with continuous catalyst regeneration. Generally, at least one compound comprising a promoter metal is provided to an existing catalyst bed of at least one catalyst particle in a commercial reforming unit. Typically, the existing catalyst is a commercially manufactured catalyst that has been loaded in the reactor vessels and is ready to facilitate the conversion of a naphtha feed or is already in the process of converting feed. In addition, the existing catalyst can also be in the process of regeneration which is periodically needed to restore the catalyst activity as described below. The addition of the compound with the promoter metal can improve the performance (i.e., the activity, selectivity, and/or deactivation characteristics) of the catalyst particle that initially does not contain or may contain less than desired amounts of the metal promoter. Additionally, such an addition can also increase the level of a metal promoter of the catalyst particle to provide further performance benefits.

The invention comprises a process for adding at least one promoter metal to a catalyst particle in situ in a catalytic naphtha reforming unit comprising introducing said at least one promoter metal while reforming reactions of a hydrocarbon naphtha feed are in progress in the reaction zone and without the need to unload and reload a catalyst or pre-catalyst into the reactors or associated vessels, wherein a compound comprising the promoter metal is introduced into the catalytic naphtha reforming unit and added to the existing catalyst in the unit that has already been reacting naphtha feed under conditions effective to add the promoter metal to a catalyst particle wherein said promoter metal is an alkali or an alkaline earth metal or combination thereof and wherein the promoter metal is effective for increasing the selectivity or the activity of the catalyst particle or decreasing the deactivation of the catalyst particle for naphtha reforming reactions.

Referring to the FIGURE, an exemplary catalytic naphtha reforming unit 100 can include a first zone 200 including a reducing atmosphere and a second zone 300, which can be a regeneration zone, including an oxidizing atmosphere. Lifts 120 and 124 can transfer the catalyst particles, generally in the form of pills, spheres, and/or extrudates, between the zones 200 and 300. Also depicted are several access points 390, which are discussed hereinafter. Such a unit 100 can provide continuous catalyst regeneration and exemplary units are disclosed in, for example, U.S. Pat. No. 5,958,216; U.S. Pat. No. 6,034,018; and US 2006/0013763 A1. The unit 100 can have portions operated at the same or different pressures, which can be atmospheric or greater. In one exemplary embodiment, a system 110 for the in situ addition of a promoter metal can be associated with the unit 100 and is further discussed below.

Typically, a hydrocarbon feed 205 and a hydrogen-containing stream 210 is combined in stream 220, heated, and then may be received in the first zone 200 that can include a reduction zone 240 and a reaction zone 280. Usually, the operating temperature in the first zone 200 is about 100° to about 600° C., preferably about 350° to about 600° C., and optimally about 500° to about 600° C. The pressure can be in the range of about 100 kPa absolute to about 1700 kPa absolute. The first zone 200 can include the combined hydrocarbon and hydrogen stream 220, with at least one particle or catalyst as described further below and a halogen component such as compound containing a fluoride or a chloride, preferably a chloride. Typically, the concentration of hydrogen in 210 is at least about 15%, preferably at least about 50%, by mole. Usually, the hydrocarbon feed 205 for catalytic reforming is a petroleum fraction known as naphtha having an initial boiling point of about 82° C. and an end boiling point of about 204° C. The catalytic reforming process is particularly applicable to the treatment of straight run naphtha feeds as well as processed naphthas comprised of relatively large concentrations of naphthenic and paraffinic hydrocarbons.

Generally, the regenerated catalyst (described in further detail hereinafter) enters the reduction zone 240 of the first zone 200 from the lift 120. The reduction zone 240 can include one or more sub-zones and/or reduction vessels and typically includes a reducing gas, such as hydrogen, to reduce one or more metal components present on the regenerated catalyst. The reducing gas can be provided via a line 250. Typically, a concentration of hydrogen in a gas is at least about 15%, preferably at least about 50%, and optimally at least about 75%, by mole, with the balance optionally being C₁ to C₆ hydrocarbons. In some preferred embodiments, a concentration of hydrogen in a gas can be about 60 to about 99.9%, by mole. The temperature can be about 120° to about 570° C., preferably about 200° to about 550° C., at a pressure of about 450 to about 1500 kPa absolute. A mole ratio of halide:H₂O, desirably Cl⁻:H₂O, is about 0.2:1 to about 0.6:1.

Afterwards, the regenerated catalyst can pass to the reaction zone 280. The combined hydrogen and hydrocarbon feed stream 220 can be introduced to zone 280. The reaction zone 280 can include one or more sub-zones and/or reaction vessels with heaters between sub-zones or reactors for conducting reforming reactions. Reforming may be defined as the total effect produced by dehydrogenation of cyclohexanes and dehydroisomerization of alkylcyclopentanes to yield aromatics, dehydrogenation of paraffins to yield olefins, dehydrocyclization of paraffins and olefins to yield aromatics, isomerization of n-paraffins, isomerization of alkylcycloparaffins to yield cyclohexanes, isomerization of substituted aromatics, hydrocracking of paraffins, and dealkylation of aromatics. Preferably, the reaction zone 280 includes a moving catalyst bed that can be countercurrent, cocurrent, crosscurrent, or a combination thereof, and the catalyst bed can be any suitable shape, such as rectangular, annular or spherical. The reaction zone 280 can be at a temperature of about 450° to about 550° C., a pressure of about 270 kPa absolute to about 1500 kPa absolute, a hydrogen to hydrocarbon mole ratio from about 1 to about 5, and a liquid hourly space velocity of about 0.5 to about 4 hour⁻¹. In some preferred embodiments, a concentration of hydrogen in a gas can be about 55 to about 65%, by mole. After the reforming reaction, the hydrocarbon stream can be sent for further processing and the catalyst can be passed to the lift 124 for regeneration.

The spent catalyst can exit the lift 124 into the regeneration zone 300. Typically, the catalyst fines are separated and removed before going to the regeneration zone 300. Generally, a temperature is about 40° to about 600° C. and a pressure is about 100 kPa absolute to about 520 kPa absolute. Most of the regeneration zone 300 can operate from about 350° to about 700° C. The regeneration zone 300 can include an incoming gas stream that has a halogen-containing compound in at least one sub-zone.

The regeneration zone 300 can include an oxidation zone 320, a redispersion zone 340, a drying zone 360, and a cooling zone 380. Note that the term “zone” can refer to an area including one or more equipment items and/or one or more sub-zones. Equipment items can include one or more vessels, heaters, separators, hoppers, drums, exchangers, pipes, pumps, compressors, blowers, valves, and controllers. Additionally, an equipment item can further include one or more zones or sub-zones. Also, in a fixed bed mode, the regeneration zone may include at least a coke burn step, a proof burn step and an oxychlorination step. In the moving bed embodiment of the FIGURE, the oxidation zone 320 can include an oxidizing atmosphere of about 0.5% to about 1.5%, by volume, oxygen. In some instances, the atmosphere may contain more than about 1.5%, by volume, oxygen. Typically, spent catalyst is contacted with the oxidizing atmosphere to remove accumulated coke on the catalyst surfaces. Moreover, chloride on the catalyst may also be stripped. Within the zone 320, coke is usually oxidized at a gas temperature of about 450° to about 600° C. The pressure can be at atmospheric pressure or greater. The catalyst can be preheated prior to leaving the oxidation zone via the hot outlet gases from the oxidation zone.

After exiting the oxidation zone 320, the catalyst particles can pass to the redispersion zone 340. In the redispersion zone 340, a gas is provided having a halogen-containing compound, such as a chloride compound for redispersing the catalyst metal. Generally, the redispersion gas also contains either chlorine or another chloro-species that can be converted to chlorine. Typically, the chlorine or chloro-species is introduced in a small stream of carrier gas added to the redispersion gas. Generally, the redispersion is effected at a gas temperature of about 425° to about 600° C., preferably about 510° to about 540° C. Typically, a concentration of chlorine of about 0.01 to 0.2 mole percent of the gas and in the presence of oxygen is used to promote redispersion. A halide:H₂O, preferably Cl⁻:H₂O, mole ratio can be about 0.07:1 to about 16:1, preferably about 0.07:1 to about 3.2:1.

The catalyst particles can pass to the drying zone 360 after passing through the redispersion zone 340. Typically, the catalyst particles are dried with air heated up to about 600° C., preferably up to about 538° C. Afterwards, the catalyst particles can be passed to the cooling zone 380 at a temperature of about 40° to about 260° C. before passing through various other subzones and then through a lock hopper to the lift 124 to repeat in a continuous manner.

Referring to the FIGURE, the catalyst and the combined hydrogen and hydrocarbon feed stream 220 can pass through the first zone 200, and the catalyst can be regenerated in the second zone 300. One exemplary application is the introduction of a compound comprising the promoter metal to the catalytic reforming process such as to add a promoter metal in situ to a catalyst particle. The compound comprising the promoter metal can be added anywhere to the unit 100, but preferably it is added to the first zone 200 including a reducing atmosphere, or the second zone 300 including an oxidizing atmosphere. The compound comprising the promoter metal can also be added simultaneously to both zones 200 and 300. Furthermore, several different compounds, each with the same or a different promoter metal can be added in multiple combinations to zones 200 and 300 at multiple locations.

If the compound comprising the promoter metal is added to the first zone 200, preferably the compound comprising the promoter metal is added to the naphtha feed stream 205, and/or to the hydrogen-containing gas stream 210, and/or to the combined hydrogen/naphtha feed stream 220 and/or the reduction zone 240, and/or the reaction zone 280 through the one or more access points 390. Alternatively, the compound comprising the promoter metal can be added to the regeneration zone 300, preferably at the oxidation zone 320, and/or the redispersion zone 340, and/or the drying zone 360, and/or the cooling zone 380 through one or more access points 390. In one embodiment, a solution of HCl, water and alkali metal or alkaline earth metal chloride compound may be provided to facilitate the addition of an alkali metal or alkaline earth metal to zone 300. Furthermore, the compound comprising the promoter metal can be added at lifts 120 and/or 124 at the access points 390.

The system 110 disclosed herein can provide at least one catalyst particle in the reforming unit 100. The at least one catalyst particle can be one or more catalyst particles circulating through the unit 100, as described above. Each catalyst particle can include a support and one or more additional components that can be incorporated in the support during, or after, the formation of the support. Generally, the support can be formed by an oil-drop method or extruded, although other methods can be utilized. The support can include a porous carrier material, such as a refractory inorganic oxide or a molecular sieve, and a binder in a weight ratio of about 1:99 to about 99:1, preferably about 10:90 to about 90:10. The carrier material can include: (1) a refractory inorganic oxide such as an alumina, a magnesia, a titania, a zirconia, a chromia, a zinc oxide, a thoria, a boria, a silica-alumina, a silica-magnesia, a chromia-alumina, an alumina-boria, or a silica-zirconia; (2) a ceramic, a porcelain, or a bauxite; (3) a silica or a silica gel, a silicon carbide, a clay or a silicate synthetically prepared or naturally occurring, which may or may not be acid treated, for example an attapulgus clay, a diatomaceous earth, a fuller's earth, a kaolin, or a kieselguhr; (4) a crystalline zeolitic aluminosilicate, such as an X-zeolite, an Y-zeolite, a mordenite, a β-zeolite, a Ω-zeolite or an L-zeolite, either in the hydrogen form or most preferably in nonacidic form with one or more alkali metals occupying the cationic exchangeable sites; (5) a non-zeolitic molecular sieve, such as an aluminophosphate or a silico-alumino-phosphate; or (6) a combination of one or more materials from one or more of these groups. In one preferred embodiment, the porous carrier is an alumina, such as a gamma alumina.

The binder can include an alumina, a magnesia, a zirconia, a chromia, a titania, a boria, a thoria, a phosphate, a zinc oxide, a silica, or a mixture thereof.

The catalyst particle may contain one or more other components added during the formation of the support and/or incorporated afterwards. These components can be one or more metals or non-metals and include: (1) a Group VIII (IUPAC 8, 9 and 10) element, (2) a Group IIIA (IUAC 13) element, (3) a Group IVA (IUPAC 14) element, and (4) a halogen component.

Preferably, the Group VIII element is platinum and the catalyst particle contains a catalytically effective amount of platinum. Typically, the catalyst contains about 0.01 to about 2%, by weight, of the Group VIII element, preferably platinum, based on the weight of the catalyst. The metal components may be incorporated in the support in any suitable manner, such as coprecipitation, ion-exchange or impregnation. A preferred method of preparing the catalyst can involve impregnating a porous carrier material with a soluble, decomposable group VIII compound. As an example, the platinum metal may be added by commingling the support with an aqueous solution of chloroplatinic, chloroiridic or chloropalladic acid. Other water-soluble compounds or complexes of group VIII metals may be employed in impregnating solutions and include platinum nitrate, platinum sulfite acid, ammonium chloroplatinate, bromoplatinic acid, platinum trichloride, platinum tetrachloride hydrate, platinum dichlorocarbonyl dichloride, dinitrodiaminoplatinum, sodium tetranitroplatinate (II), palladium chloride, palladium nitrate, palladium sulfate, diamminepalladium (II) hydroxide, tetraamminepalladium (II) chloride, hexa-amminerhodium chloride, rhodium carbonylchloride, rhodium trichloride hydrate, rhodium nitrate, sodium hexachlororhodate (III), sodium hexanitrorhodate (III), iridium tribromide, iridium dichloride, iridium tetrachloride, sodium hexanitroiridate (III), potassium or sodium chloroiridate, or potassium rhodium oxalate. Use of these compounds may also provide at least part of the halogen component, particularly by adding an acid, such as hydrogen chloride. In addition, the impregnation can occur after calcination of the support.

Similarly, the catalyst particle can contain a group IIIA metal incorporated in the support in any suitable manner, such as coprecipitation, ion-exchange or impregnation. A preferred method of preparing the catalyst can involve impregnating a porous carrier material with a soluble, decomposable group IIIA compound. As an example, an indium metal may be added by an impregnating aqueous solution of indium chloride (InCl₃) or indium nitrate (In(NO₃)₃) and hydrochloric acid. Use of these compounds may also provide at least part of the halogen component. Other solution modifiers which may be used include nitric acid and ammonia hydroxide.

The catalyst particle can contain another promoter from Group IVA and/or other elements. A preferable group IVA element is tin, germanium, or lead, more preferably tin. Yet another promoter that optionally can be included is rhenium; a rare earth metal, such as cerium, lanthanum, and/or europium; phosphorus; nickel; iron; tungsten; molybdenum; titanium; zinc; or cadmium. Also, the catalyst can contain a combination of these elements. Generally, the catalyst contains about 0.001 to about 5%, by weight, based on the weight of the catalyst. Optionally, the catalyst may also contain one or more group IA and IIA metals (alkali and alkaline-earth metals) in about 0.01 to about 5%, by weight, based on the weight of the catalyst.

In the manufacture of the catalyst particle, the promoter, such as a group IVA metal, may be incorporated in the catalyst in any suitable manner to achieve a homogeneous dispersion, such as by coprecipitation with the porous carrier material, ion-exchange with the carrier material, or impregnation of the carrier material at any stage in the preparation. One method of incorporating the group IVA metal component into the catalyst composite involves the utilization of a soluble, decomposable compound of a group IVA metal to impregnate and disperse the metal throughout the porous carrier material. The group IVA metal component may be impregnated either prior to, simultaneously with, or after the other components are added to the carrier material. Thus, the group IVA metal component may be added to the carrier material by commingling the carrier material with an aqueous solution of a suitable metal salt or soluble compound such as stannous bromide, stannous chloride, stannic chloride, or stannic chloride pentahydrate; or germanium oxide, germanium tetraethoxide, or germanium tetrachloride; or lead nitrate, lead acetate, or lead chlorate. The utilization of metal chloride compounds may also provide at least part of the halogen component. In one preferred embodiment, at least one organic metal compound such as trimethyltin chloride and/or dimethyltin dichloride are incorporated into the catalyst during the peptization of the inorganic oxide binder, preferably during peptization of alumina with hydrogen chloride or nitric acid.

The catalyst particle can also contain a halogen component and can be fluorine, chlorine, bromine, iodine, astatine or a combination thereof. Preferably the halogen component is chlorine. The catalyst particle can contain typically about 0.1 to about 10%, preferably about 0.5 to about 2.0%, and optimally about 0.7 to about 1.3%, by weight, of the halogen component, preferably chlorine, based on the weight of the catalyst. The halogen component can be added with one or more of the metals and/or one or more promoters. Furthermore, the halogen component can be adjusted by employing a halogen-containing compound, such as chlorine or hydrogen chloride, in air or an oxygen atmosphere at a temperature of about 370 to about 600° C. Water may be present during the contacting step in order to aid in the adjustment.

For the catalyst particle, the components can be impregnated together, e.g., co-impregnated, or separately with one or more optional calcination steps there between. The catalyst particles or catalysts can be made to methods known to those skilled in the art, as disclosed in US 2006/0102520 A1 and/or U.S. Pat. No. 5,883,032. The supports can be formed into spheres or extrudates optionally with one or more components.

The amount of material contained by the catalyst particles can be measured by methods known to those of skill in the art. As an example, UOP method 274-94 can be used for platinum and other group VIII metals, UOP method 303-87 can be used for tin and other group IVA metals, and UOP method 873-86 can be used for noble metals and modifiers, in catalysts by inductively coupled plasma atomic emission spectroscopy. The halogen component, particularly chloride, can be determined by UOP method 979-02 by x-ray fluorescence or by UOP method 291-02 by potentiometric titration.

One class of suitable compounds that contain a promoter metal are those that are soluble in various hydrocarbons or a hydrocarbon naphtha feed. These types of compounds can consist of organometallic compounds, i.e. compounds that contain a carbon-metal linkage including, but not limited to, methyllithium, phenyllithium, methylmagnesiumchloride, phenylmagnesiumchloride methylpotassium, phenylsodium, methylsodium; and diethylmagnesium. Another class of suitable compounds that contain a promoter metal are those that can be made into a solution with water or water and an acid. The compounds can include halides, nitrates, acetates, tartrates, citrates, carbonates, rhenates, tungstates, and molybdates. The preferred compounds are halides and more preferred are chlorides such as, but not limited to, lithium chloride, sodium chloride, potassium chloride, rubidium chloride, cesium chloride, beryllium chloride, magnesium chloride, calcium chloride, strontium chloride and barium chloride. The chloride compounds are specifically advantageous since these can also add to the chloride component of the catalyst and not introduce potential undesired impurities. Other compound classes with promoter metals may also be used.

Generally, from the compound comprising the promoter metal, a catalytically effective amount is added to the catalyst particle. Typically, at least about 0.003 wt % (30 wppm) preferably at least about 0.005 wt % (50 wppm) of the Group IA or IIA element. Generally, for the addition of the compound with the promoter metal, a solution of the compound is made, added to a holding tank and then pumped to zones 200 and 300 typically at addition points 390. The pipe or lines can be heated to aid in the transfer of the compound to zones 200 and 300. Optionally, an inert carrier gas such as nitrogen can be added to the line to aid in the transfer of the compound to zones 200 and 300. The content of the solution depends on the class of compound used. For the class of compounds that are soluble in water and/or water and inorganic acids such as HCl, a solution is made with water, acid and the compound that contains the promoter metal. For organometallic compounds that contain the promoter metal, a solution of the organometallic compound can be made with a small portion of the naphtha feed or other organic solvent with 6 to 12 carbons which can include for example benzene, toluene, n-hexane, n-heptane, methylcyclohexene, THF, and mixtures thereof. The preferred locations for the addition of the organometallic compounds are to streams 205, 210, 220 and zone 280. In general, for all compounds added to zones 200 and 300, the compound will volatilize under reforming conditions, adsorb onto the catalyst and/or decompose and/or react leaving a deposited promoter metal species on the catalyst.

The following example is intended to further illustrate the invention. This embodiment and demonstration of the invention is not meant to limit the claims of this invention to the particular details of the example.

### EXAMPLES

The promoter compound containing the alkali or alkaline earth metal, can be added to the reforming unit on the reactor side and/or on the regeneration side. In a generalized process, the promoter compound may be added to the regeneration vessel while in a second generalized scheme the promoter compound may be added to a naphtha feed. The promoter compound may be added at a variety of locations within the process.

### Example 1

To demonstrate that an alkali metal such as potassium can be deposited on a reforming catalyst under an oxidizing atmosphere during oxychlorination conditions, 200 cc of a fresh commercial continuous regeneration catalyst comprising Pt, Sn, and Cl on gamma alumina was loaded into a quartz reactor in four beds containing 50 cc each of the catalyst. A fifth bed was loaded with 200 cc of the gamma alumina support. The beds were separated by quartz wool and spacers were located above the top bed. The beds were numbered sequentially with Bed 5 located nearest to the top of the reactor, and bed 1 with the gamma alumina support located nearest to the bottom of the reactor. The initial potassium levels of the reforming catalyst and of the support were less than 0.001 wt % (less than 10 wppm).

A regeneration procedure was conducted in the reactor. The steps of the regeneration procedure included in order (1) a heat up period in air ramping the temperature from ambient to 510° C. at 1.4° C./min; (2) introduction of Cl₂ and a HCl-containing solution as described below, during an oxychlorination step for 8 hours at 510° C.; (3) a cool down period with full air to reach 93° C.; (4) a reheat/ramp period using 15 mol % hydrogen stream ramping from 93° C. to 566° C. at 1.5° C./min; (5) a reduction step for 2 hours at 566° C.; and (6) a final cool down period to 93° C. in 15 mol % hydrogen.

100 cc of a solution of HCl, KCl, and water was prepared by mixing 2.60 g KCl, 13.26 g HCl solution (36.5 wt % HCl), and 88.89 g water. The solution was flowed to the reactor via a pump. A total of 48.65 cc of the solution was injected, continuously, over the 8 hour oxychlorination step. Inside the reactor, the solution dripped onto the spacers above Bed 5. The solution volatized and was swept to the catalyst by the air stream that entered through a second reactor inlet line.

Upon completion of the regeneration process, each catalyst bed was unloaded keeping each bed separate and analyzed by inductively coupled plasma atomic emission spectroscopy using UOP Method 873-86. Bed 5 contained 60 wppm potassium while beds 1, 2, 3 and 4 each contained less than 10 wppm potassium. This experiment demonstrated that a compound comprising potassium can be introduced into a regeneration system with potassium successfully being added to a reforming catalyst under oxychlorination conditions.

### Example 2

To demonstrate that an alkaline earth metal such as magnesium can be deposited on a reforming catalyst under an oxidizing atmosphere during oxychlorination conditions, 200 cc of a fresh commercial continuous regeneration catalyst comprising Pt, Sn, and Cl on gamma alumina was loaded into a quartz reactor in four beds containing 50 cc each of the catalyst. A fifth bed was loaded with 200 cc of the gamma alumina support. The beds were separated by quartz wool and spacers were located above the top bed. The beds were numbered sequentially with Bed 5 located nearest to the top of the reactor, and bed 1 with the gamma alumina support located nearest to the bottom of the reactor. The initial magnesium level of the reforming catalyst was 0.001 wt % (10 wppm) and the initial magnesium level of the support was less than 0.001 wt % (less than 10 wppm).

A regeneration procedure was conducted in the reactor. The steps of the regeneration procedure included (1) a heat up period in air ramping the temperature from ambient to 510° C. at 1.4° C./min. (2) introduction of Cl₂ and a HCl-containing solution as described below, during an oxychlorination step for 8 hours at 510° C. (3) Cool down period with full air to reach 93° C. (4) a reheat/ramp period using 15 mol % hydrogen stream ramping from 93° C. to 566° C. at 1.5° C./min. (5) a reduction step for 2 hours at 566° C. and (6) a final cool down period to 93° C. in 15 mol % hydrogen.

100 cc of a solution of HCl, MgCl₂, and water was prepared by mixing 5.19 g MgCl₂, 13.26 g HCl solution (36.5 wt % HCl), and 88.89 g water. The solution was flowed to the reactor via a pump. A total of 48.65 cc of the solution was injected, continuously, over the 8 hour oxychlorination step. Inside the reactor, the solution dripped onto the spacers above Bed 5. The solution volatized and was swept to the catalyst by the air stream that entered through a second reactor inlet line.

Upon completion of the regeneration process, each catalyst bed was unloaded keeping each bed separate and analyzed by inductively coupled plasma atomic emission spectroscopy using UOP Method 873-86. Bed 5 contained 30 wppm magnesium while beds 2, 3 and 4 each contained 10 wppm magnesium. Bed 1 with the support contained less than 10 wppm. This experiment demonstrated that a compound comprising magnesium can be introduced into a regeneration system with magnesium successfully being added to a reforming catalyst under oxychlorination conditions.

In a moving bed application, the catalyst particles in the bed physically closest to the location of introduction of the alkali metal or the alkaline earth metal may receive the highest concentration of the metal addition, but since the particles move through the regeneration system, and the alkali metal or alkaline earth metal may be periodically added, with time the alkali metal or alkaline earth metal can be added over the inventory of the reforming catalyst in the operating unit.

### Example 3

This example demonstrates the increases in total aromatic yields without significant activity losses obtained on reforming catalysts made with low levels of alkali metals. Spherical reforming catalysts were made containing Pt, Sn, Cl and the alkali metals K or Li. The alumina base was made via the oil drop method where the Sn was incorporated into the aluminum sol. The alumina base was then impregnated with chloroplatinic acid with HCl and H₂O, dried, oxychlorinated and reduced. The sample was then further oxychlorinated at 510° C., and reduced in 15 mol % H₂/N₂ at 565° C. (Catalyst A) in order to be consistent with the treatments for Catalysts B and C below. The composition of Catalyst A was 0.25 wt % Pt, 0.29 wt % Sn, and 1.04 wt % Cl.

Catalyst B was made on a similar alumina base as Catalyst A. The alumina base was impregnated with a solution of potassium chloride with H₂O, calcined, impregnated with chloroplatinic acid with HCl and H₂O, dried, oxychlorinated at 510° C., and reduced in 15 mol % H₂/N₂ at 565° C. (Catalyst B). The composition of Catalyst B was 0.25 wt % Pt, 0.29 wt % Sn, 1.06 wt % Cl and 0.007 wt % K (70 wppm).

Catalyst C was made on a similar alumina base as Catalyst A. The alumina base was impregnated with a solution of lithium nitrate in H₂O, calcined, impregnated with chloroplatinic acid with HCl and H₂O, dried, oxychlorinated at 510° C., and reduced in 15 mol % H₂/N₂ at 565° C. (Catalyst C). The composition of Catalyst C was 0.25 wt % Pt, 0.29 wt % Sn, 1.01 wt % Cl and 0.015 wt % Li (150 wppm).

Catalysts A, B and C were pilot plant tested in a reforming pilot plant at a constant research octane of 104.3 by continuously increasing the furnace temperatures. The conditions were hydrogen/hydrocarbon mole ratio of 3, 1.7 hour⁻¹ liquid hourly space velocity, and 42 hours on stream. The naphtha feed for each run was substantially the same and contained paraffins, naphthenes and aromatics. Two sets of runs were done comparing Catalysts A and B and then comparing Catalysts A and C. Referring to the following Table, the addition of a low level of potassium, 70 wppm (Catalyst B), resulted in an increase in total aromatic yield of 0.29 wt % over the reference Catalyst A at about the same temperature (activity). From the following Table, the addition of 150 wppm of Li (Catalyst C) resulted in an increase in total aromatic yield of 0.85 wt % over the reference Catalyst A with a loss of activity of about 4° C. The following Table further shows a benefit in reduced lights-ends C₁+C₂ and C₃+C₄ yields for both alkali-containing catalysts as compared to Catalyst A.

TABLE

| | | | Delta | | | Delta |
|---|---|---|---|---|---|---|
| Run | 1 | 2 | B vs. A | 3 | 4 | C vs. A |
| Catalyst | A | B | | A | C | |
| Temperature, | 510.2 | 509.9 | −0.3 | 511.3 | 515.7 | +4.4 |
| ° C. | | | | | | |
| Total Aromatic | 69.90 | 70.19 | +0.29 | 70.21 | 71.06 | +0.85 |
| Yield, wt % | | | | | | |
| C₁ + C₂, wt % | 3.28 | 3.14 | −0.14 | 2.95 | 2.81 | −0.14 |
| C₃ + C₄, wt % | 7.57 | 7.44 | −0.13 | 7.83 | 7.24 | −0.59 |

1. A process for adding at least one promoter metal to a catalyst particle in situ in a catalytic naphtha reforming unit comprising introducing said at least one promoter metal while reforming reactions of a hydrocarbon naphtha feed are in progress in the reaction zone and without the need to unload and reload a catalyst or pre-catalyst into the reactors or associated vessels, wherein a compound comprising the promoter metal is introduced into the catalytic naphtha reforming unit and added to the existing catalyst in the unit that has already been reacting naphtha feed under conditions effective to add the promoter metal to a catalyst particle wherein said promoter metal is an alkali or an alkaline earth metal or combination thereof and wherein the promoter metal is effective for increasing the selectivity or the activity of the catalyst particle or decreasing the deactivation of the catalyst particle for naphtha reforming reactions.

2. The process of claim 1, wherein the catalytic naphtha reforming unit is a moving bed continuous regeneration unit and the compound comprising the promoter metal is introduced to a zone selected from the group consisting of the oxidation zone, the redispersion zone, the drying zone, the cooling zone, or a combination thereof of the moving bed continuous regeneration unit.

3. The process of claim 2 wherein the zone is operated at a temperature from about 40 to about 600° C. and a pressure from about 100 kPa absolute to about 520 kPa absolute.

4. The process of claim 1, wherein the catalytic naphtha reforming unit is a fixed bed unit and the compound comprising the promoter metal is introduced to the regeneration gas during a step selected from the group consisting of the coke burn step, the proof burn step, the oxychlorination step, or a combination thereof when the catalyst is being regenerated.

5. The process of claim 4 wherein the step conducted at a temperature from about 40 to about 700° C. and a pressure from about 100 kPa absolute to about 520 kPa absolute.

6. The process of claim 1, wherein the compound comprising the promoter metal is introduced to a naphtha feed stream entering the catalytic naphtha reforming unit.

7. The process of claim 1, wherein the promoter metal is selected from the group consisting of Li, Na, K, Rb, Cs, Be, Mg, Ca, Sr, and Ba.

8. The process of claim 1 wherein the promoter metal further comprises a rare earth metal.

9. The process of claim 1 wherein the promoter metal is potassium, lithium, or magnesium.

10. The process of claim 1 wherein the compound comprising the promoter metal is in solution.

11. The process of claim 1, wherein the promoter metal comprises an alkali metal or alkaline earth metal, the catalyst particle comprises no more than about 1%, by weight, of an alkali metal or alkaline earth metal, based on the weight of the catalyst particle before the adding of at least one promoter metal to the catalyst particle in situ.

12. The process of claim 1 wherein the catalyst particle comprises a support and at least one catalytic metal deposited on the support.

13. The process of claim 1, wherein the reforming unit comprises:
a reduction zone;
a reaction zone; and
a regeneration zone comprising:
an oxidation zone,
a redispersion zone,
a drying zone, and
a cooling zone; and
wherein the process further comprises adding the compound comprising the promoter metal to at least one of the reduction zone, the reaction zone and the regeneration zone.

14. The process of claim 13, wherein the compound comprising the promoter metal is introduced to the reduction zone or the reaction zone and the addition of the promoter metal to the catalyst particle occurs in a reducing atmosphere comprising hydrogen.

15. The process of claim 13, wherein the compound comprising the promoter metal is introduced to the catalytic naphtha refining unit as a co-feed with a halogen containing compound and water.

16. The process of claim 13, wherein compound comprising the promoter metal is added to the regeneration zone and the addition of the promoter metal to the catalyst particle occurs in an oxidizing atmosphere comprising oxygen.

17. A system for the in situ addition of a promoter metal in a reforming unit comprising a first zone comprising a reducing atmosphere, and a second zone comprising an oxidizing atmosphere, the system comprising the reforming unit containing at least one compound comprising the promoter metal added to at least one catalyst particle and operating at conditions to facilitate addition of an effective amount of the promoter metal to the at least one catalyst particle for increasing the selectivity or activity of the catalyst particle or decreasing the deactivation of the catalyst particle.

18. The system of claim 17, wherein the promoter metal catalyst component comprises alkali metals or alkaline earth metals.
